(19) United States
(12) Patent Application Publication
(10) Pub. No.: US 2012/0270116 A1
(43) Pub. Date: Oct. 25, 2012

(54) METAL AIR BATTERY AND METHOD FOR PREPARING THE SAME

(75) Inventors: Ji Sung CHO, Gyeonggi-do (KR); Sang Kyun Lee, Gyeonggi-do (KR); Hyun Chul Jung, Gyeonggi-do (KR); Bae Kyun Kim, Gyeonggi-do (KR); Chang Ryul Jung, Seoul (KR)

(73) Assignee: SAMSUNG Electro-Mechanics Co., Ltd.

(21) Appl. No.: 13/357,353

(22) Filed: Jan. 24, 2012

(30) Foreign Application Priority Data
Apr. 20, 2011 (KR) 10-2011-0036963

(51) Int. Cl. H01M 12/06; H01M 8/00

(52) U.S. Cl. 429/405; 429/535

(57) ABSTRACT

Disclosed is a metal air battery a metal anode and an air cathode, wherein the metal anode includes an organic electrolyte and the air cathode includes an aqueous electrolyte, and a method for preparing the same.

The metal air battery having a structure according to the exemplary embodiment of the present invention may prevent the electrolytes of the cathode and the anode from being mixed and activate battery reaction, thereby preparing a high-capacity battery.

### CROSS REFERENCE(S) TO RELATED APPLICATIONS

This application claims the benefit under 35 U.S.C. Section 119 of Korean Patent Application Serial No. 10-2011-0036963, entitled “Metal air battery and method for preparing the same” filed on Apr. 20, 2011, which is hereby incorporated by reference in its entirety into this application.

### BACKGROUND OF THE INVENTION

1. Technical Field

The present invention relates to a high-capacity metal air battery with excellent safety and a method for preparing the same.

2. Description of the Related Art

Recently, because of increased emissions of carbon dioxide due to consumption of fossil fuels, a sudden change in crude oil price, or the like, a technology of converting an energy source for a car from gasoline or diesel into electric energy has recently been interested.

Some technologies for commercializing an electric car are already in practice, but a need exists for a technology for implementing high performance and low costs of a lithium ion battery as a long-distance travelling battery. However, the current lithium ion battery is difficult to use as a long-distance travelling battery due to a limitation in battery capacity and thus, a larger number of lithium ion batteries are mounted in a car to remarkably increase a car price.

In order to popularize an electric car, energy density about 6 to 7 times larger than a current level is needed. As a result, a metal air battery having energy density theoretically much larger than the lithium ion battery has been interested. A rechargeable battery using a metal as an anode active material and oxygen in the air as a cathode has been interested. Since the cathode, the oxygen needs not to be included in a battery cell, the metal air battery may theoretically have capacity larger than the lithium ion battery and thus, has been studied as a batter for a car.

At the time of discharging the metal air battery, an open voltage at approximately 2.8V when considering a yield of metal oxide (Metal +O₂→Metal Oxide) that is generated by reacting a metal with oxygen is most effective. In this case, energy per unit weight that may be theoretically stored is 3000 to 5000 Wh/Kg, which is a much higher level than 300 Wh/Kg of the lithium ion secondary battery.

Actually, oxygen is obtained from air and therefore, does not have to be stored in a battery except for a special case such as a space, underwater, or the like. Therefore, the effective performance of the metal air battery is further increased. For reference, the lithium ion battery has a discharge capacity of 120 to 150 mAh/g, while the metal air battery has a discharge capacity has a discharge capacity of 700 to 3000 mAh/g.

Therefore, the metal (Li) air battery may be theoretically implemented as a large-capacity battery and therefore, has been interested as a next generation large-capacity battery

However, the lithium air battery reported up to now has the following problems.

1) Pores of a separation membrane stops due to the accumulation of solid reaction products (Li₂O) in an anode, thereby degrading the efficiency of charging and discharging and causing a short.

2) Moisture in the air reacts with the metal lithium, thereby generating dangerous hydrogen gas.

3) Nitrogen in the air reacts with the metal lithium, thereby hindering discharge.

### SUMMARY OF THE INVENTION

An object of the present invention is to provide a high-capacity metal air battery without degrading charging and discharging efficiency, causing a short, generating hydrogen gas, hindering discharging, or the like.

Another object of the present invention is to provide a method for preparing a high-capacity metal air battery.

According to an exemplary embodiment of the present invention, there is provided a metal air battery, including: a metal anode and an air cathode, wherein the metal anode includes an organic electrolyte and the air cathode includes an aqueous electrolyte.

The metal anode may be one or more selected from a group consisting of lithium (Li), sodium (Na), potassium (K), calcium (Ca), Magnesium (Mg), aluminum (Al), zinc (Zn), and an alloy thereof.

The air cathode may include one or more selected from a group consisting of precious metals, metal oxides, and organic metal complexes.

The precious metal may be one or more selected from platinum (Pt), gold (Au), and silver (Ag), the metal oxide may be one or more selected from manganese (Mn), nickel (Ni), and cobalt (Co), and the organic metal complex may be one or more selected from metalloporphyrin and metal phthalocyanine.

The organic electrolyte and the aqueous electrolyte may include a lithium containing compound as an electrolytic salt.

The lithium containing compound may be one or more selected from a group consisting of LiPF₆, LiBF₄, LiClO₄, LiN(SO₂CF₃)₂, LiN(SO₂C₂F₅)₂, CF₃SO₃Li, LIC(SO₂CF₃)₃, LiAsF₆, LiSbF₆, LiI, LiCF₃CO₂, LiPF₃ (C₂F₅)₃, LiF₃(C₂F₅)₃, LiF₃(CF₃)₃, LiPF₄(C₂F₅)₂, LiPF₄(CF₃)₂, LiPF₅(C₂F₅), and LiPF₅(CF₃).

A solvent of the organic electrolyte may include one or more selected from a group consisting of ethylene carbonate, propylene carbonate, butylene carbonate, ethyl methyl carbonate, diethyl carbonate, dimethyl carbonate, dimethyl ether, diethyl ether, tetrahydrofuran, methyl tetrahydrofuran, dioxolane, methyl dioxolane, sulfolane, γ-butyrolanctone, dimethyl formamide, dimethyl sulfoxide, dimethoxy ethane, ethyl acetate, methyl acetate, methyl lactate, and ethyl propionate.

The aqueous electrolyte may be an alkaline electrolyte having a pH of 10 to 12.5.

A separation membrane may be included between the organic electrolyte and the aqueous electrolyte.

The separation membrane may be a solid separation membrane that transmits only metal ions configuring a metal anode.

The solid separation membrane may be a solid inorganic separation membrane made of one or more selected from a group consisting of silicon (Si), titanium (Ti), zirconium (Zr), aluminum (Al), calcium (Ca), and magnesium (Mg).

The separation membrane may be an organic polymer/inorganic complex separation membrane without reactivity against the electrolyte.

The organic polymer may be an oxygen (—O—) atom containing organic polymer compound of a weight-average molecular average of 100,000 to 5,000,000.

The organic polymer compound may be one or more selected from polyethylene oxide, polypropylene oxide, polyoxymethylene, and derives thereof.

The inorganic matter may be one or more selected from a group consisting of silicon (Si), titanium (Ti), zirconium (Zr), aluminum (Al), calcium (Ca), and magnesium (Mg).

According to another exemplary embodiment of the present invention, there is provided a method for preparing a metal air battery, including: preparing a metal anode; preparing an air cathode; forming a solid separation membrane between the metal anode and the air cathode; impregnating an organic electrolyte in the metal anode; and impregnating an aqueous electrolyte in the air cathode.

### BRIEF DESCRIPTION OF THE DRAWINGS

FIG. 1 is a diagram showing a structure of an anode, a cathode, and an electrolyte according to an exemplary embodiment of the present invention.

FIG. 2 is a structure of a battery according to the exemplary embodiment of the present invention.

### DESCRIPTION OF THE PREFERRED EMBODIMENTS

Hereinafter, an exemplary embodiment of the present invention will be described in detail.

A metal air battery according to the exemplary embodiment of the present invention is a metal air battery that includes a metal anode and an air cathode, wherein the metal anode includes an organic electrolyte and the air cathode include an aqueous electrolyte. In addition, a separation membrane is included between the organic electrolyte of the metal anode and the aqueous electrolyte of the air cathode.

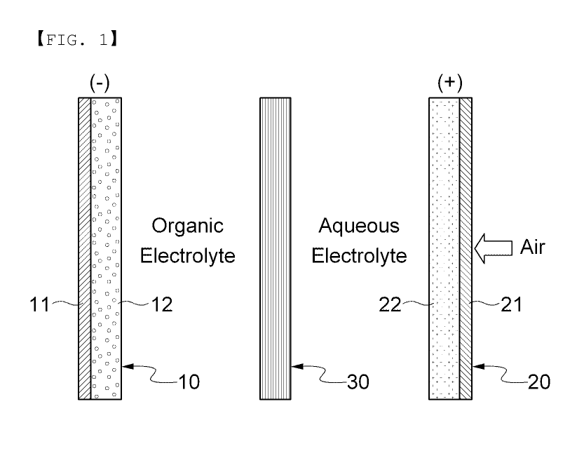

The structure is shown in FIG. 1.

An anode 10 of the exemplary embodiment of the present invention includes an active material layer 12 where active material slurry including one or more metal as an active material is applied to an anode collector 11.

As long as the anode may absorb and emits metal ions, any anode may be used without being particularly limited. A detailed example of the metal ion may include one or more selected from a group consisting of lithium (Li), sodium (Na), potassium (K), calcium (Ca), Magnesium (Mg), aluminum (Al), zinc (Zn), and an alloy thereof.

If the anode collector to which the anode is applied has conductivity, any anode collector may be used without being particularly limited. For example, stainless steel, copper, nickel, and an alloy thereof, or the like, may be used. In addition, the thickness thereof may be about 10 to 300 μm. An example of the current collector may include a metal foil, an etched metal foil, or ones having holes penetrating through front and rear surfaces, such as an expanded metal, a punching metal, a net, foam, or the like.

In addition, a cathode 20 of the exemplary embodiment of the present invention includes an active material layer 22 where slurry using air as an active material and including a catalyst and other additives is applied to a cathode collector 21.

As a material of the cathode collector 21, a porous carbon material having excellent corrosion-resistance while being lighter than a metal may be used. For example, a carbon fiber, an activated carbon material, or the like, may be used. The cathode collector 21 may have a porous structure in order to smoothly diffuse external oxygen. The porous structure is not particularly limited, but may have a porosity of 10 to 40%.

Since the metal air battery according to the exemplary embodiment of the present invention uses oxygen as the cathode, the cathode collector 21 may simultaneously perform a function of the case (exterior material) of the metal air battery.

In order to use the active material as the external oxygen, a separate porous membrane may be installed to smooth the introduction of oxygen and a separate oxygen supply device may be installed.

The air cathode according to the exemplary embodiment of the present invention may include a catalyst to promote the reaction of oxygen at the time of using oxygen as the cathode.

A detailed example of the catalyst may include one or more selected from a group consisting of precious metals, metal oxides, and organic metal complexes, but is not limited thereto.

An example of the precious metals may include one or more selected from platinum (Pt), gold (Au), and silver (Ag), an example of the metal oxides may include one or more selected from manganese (Mn), nickel (Ni), and cobalt (Co), and an example of the organic metal complexes may include one or more selected from metalloporphyrin and metal phthalocyanine.

The content of the catalyst may be included as 1 to 10 wt % of a total composition of the air cathode. When the content of the catalyst is below 1 wt %, it may be difficult to perform its role and when the content of the catalyst exceeds 10 wt %, the problem of dispersion degradation and costs may occur.

In addition to the catalyst, a conductive material, a binder, or the like, may be added. As long as they are used as the general secondary battery and metal air battery, any material may be used and the content thereof may be included at a general level.

Meanwhile, in the exemplary embodiment of the present invention, the metal anode and the air cathode include different electrolyte. In detail, the metal anode includes the organic electrolyte and the air cathode includes the aqueous electrolyte, as shown in FIG. 1. The exemplary embodiment of the present invention has a structure where the organic electrolyte is insulated from the aqueous electrolyte by the separation membrane 30.

In the exemplary embodiment of the present invention, when the aqueous electrolyte is used in the air cathode, oxygen O₂ introduced from the outside reacts with four electrons, thereby further improving the reactivity than using the organic electrolyte. Therefore, as in the exemplary embodiment of the present invention, the case in which the cathode and the anode use different electrolytes may further increase the capacity of the battery than the case in which the cathode and the anode use a non-aqueous electrolyte.

In addition, in the case of the general metal air battery, since components such as nitrogen N₂, or the like, are included in oxygen used as the cathode, the nitrogen reacts with the metal of the anode, thereby causing the problem in that the anode collapses.

However, in the exemplary embodiment of the present invention, the cathode and the anode has a structure where the cathode and the anode include different electrolytes and are insulated from each other by the solid separation membrane, such that water, oxygen, or the like, used as the cathode may not transmit the solid separation membrane, thereby improving the battery stability without the risk that the water, the oxygen, or the like, reacts with the metal of the anode.

Further, the exemplary embodiment of the present invention uses the charging-only cathode at the time of charging, thereby preventing the corrosion and deterioration of the air cathode due to the charging.

The organic electrolyte and the aqueous electrolyte used for the metal anode and the air cathode may include lithium containing compounds as an electrolytic salt. An example of the lithium containing compounds may include one or more selected from a group consisting of LiPF₆, LiBF₄, LiClO₄, LiN(SO₂CF₃)₂, LiN(SO₂C₂F₅)₂, CF₃SO₃Li, LIC(SO₂CF₃)₃, LiAsF₆, LiSbF₆, LiI, LiCF₃CO₂, LiPF₃(C₂F₅)₃, LiF₃(C₂F₅)₃, LiF₃(CF₃)₃, LiPF₄(C₂F₅)₂, LiPF₄(CF₃)₂, LiPF₅(C₂F₅), and LiPF₅(CF₃).

An example of a solvent of the organic electrolyte may include one or more selected from a group consisting of ethylene carbonate, propylene carbonate, butylene carbonate, ethyl methyl carbonate, diethyl carbonate, dimethyl carbonate, dimethyl ether, diethyl ether, tetrahydrofuran, methyl tetrahydrofuran, dioxolane, methyl dioxolane, sulfolane, γ-butyrolactone, dimethyl formamide, dimethyl sulfoxide, dimethoxy ethane, ethyl acetate, methyl acetate, methyl lactate, and ethyl propionate. Among others, the ethylene carbonate (EC) and the propylene carbonate (PC) of 50 wt % or more of the total solvent may be added in terms of obtaining various temperature characteristics.

In addition, as the aqueous electrolyte used for the air cathode, an alkaline electrolyte having a pH of 10 to 12.5 may be used, for example, an alkaline aqueous electrolyte such as KOH, NaOH may be used.

As the separation membrane used between the organic electrolyte and the aqueous electrolyte, the solid separation membrane that transmits only the metal ions configuring the metal anode may be used. The solid separation membrane transmits only the metal ions and does not transmit the rest ions. As a result, it is possible to effectively prevent two electrolytes from being mixed and the solid products from being generated at the cathode side.

The solid separation membrane may be a solid inorganic separation membrane of one or more metal selected from a group consisting of silicon (Si), titanium (Ti), zirconium (Zr), aluminum (Al), calcium (Ca), and magnesium (Mg).

In addition, the separation membrane may use an organic polymer/inorganic complex separation membrane without reactivity against the electrolyte. When the separation membrane is the organic polymer/inorganic complex separation membrane without reactivity against the electrolyte, the organic polymer may be an oxygen (—O—) atom containing organic polymer compound having a weight-average molecular weight of 100,000 to 5,000,000. For example, as a polyethylene ether-based compound, one or more selected from polyethylene oxide, polypropylene oxide, polyoxymethylene, and derivatives thereof may be used.

If the organic polymer may be used as a solid electrolyte membrane, the organic polymer is not particularly limited. The organic polymer may have a weight-average molecular weight of about 100,000 to 5,000,000, preferably, 500,000 to 5,000,000, most preferably, 1,000,000 to 4,000,000.

In addition, the inorganic matter of the organic polymer/inorganic complex separation membrane may be one or more selected from a group consisting of silicon (Si), titanium (Ti), zirconium (Zr), aluminum (Al), calcium (Ca), and magnesium (Mg). Among others, the metal oxides such as silicon, titanium, and zirconium may be more preferable and the silicon oxide (SiO₂) may be most preferable in terms of low costs and easiness of manufacturing.

If the battery case used in the exemplary embodiment of the present invention may accommodate the air cathode including the aqueous electrolyte, the metal anode including the organic electrolyte, and the non-aqueous electrolyte, the battery case is not particularly limited. For example, the battery case may be formed in any shape, such as a coin shape, a flat shape, a cylindrical shape, a laminate shape, or the like.

Further, the battery case according to the exemplary embodiment of the present invention may be formed in a shape opened or closed to the air. In the case of the closed battery case, a pipe of supplying and discharging air may be mounted in the closed battery case. In this case, the gas supplied and discharged through the pipe may preferably has high oxygen density and may be more preferably pure oxygen. In addition, it is preferable to increase the oxygen density at the time of discharging and reduce the oxygen density at the time of charging.

Hereinafter, a method for preparing the metal air battery according to the exemplary embodiment of the present invention will be described.

First, the basis of the design is that as the anode, the organic electrolyte is used in the metal aluminum and as the cathode, the aqueous electrolyte is used in the air. When the solid electrolyte transmitting only the metal ions between the organic electrolyte of the anode side and the aqueous electrolyte of the cathode are used as the separation membrane, the high-capacity aluminum-air battery structure that may prevent two electrolytes from being mixed is completed.

In the above structure, the reaction such as the following equations 1 and 2 occurs at each cathode and anode. The total reaction is as the follow equation 3.

Cathode: 3/2O₂+3H₂O+6e⁻→6OH⁻ (Equation 1)

Anode: 2Al+6OH⁻→Al₂O₃+3H₂O+3e⁻ (Equation 2)

Total Reaction: 2Al+3/2O₂→Al₂O₃ (2.71V) (Equation 3)

In addition, the charging and discharging reaction equation of the metal-air battery according to the exemplary embodiment of the present invention is as follows.

First, the electrode reaction at the time of discharging is as follows.
1) Reaction at anode: Al→Al³⁺+3e⁻

As the metal ion, electrons are supplied to a conducting wire by melting aluminum (Al³⁺) as the metal ion in the organic electrolyte. The melted aluminum Al³⁺ transmits the solid separation membrane and moves to the aqueous electrolyte of the cathode.
2) Reaction at cathode: 3/2O₂+3H₂O+6e⁻6OH⁻

Electrons are supplied to the conducting wire to react oxygen in the air with water at the surface of fine carbon, thereby generating hydrogen ion (OH⁻). The hydrogen ion meets oxygen and the aluminum (Al³⁺) of the cathode aqueous electrolyte to generate aqueous aluminum hydroxide (AlOH₃).

In addition, the reaction at the electrode at the time of charging is as follows. 1) Reaction at the anode: Al+3e−→Al³⁺

Electrons are supplied to the conducting wire and the aluminum (Al³⁺) transmits the solid separation membrane in the cathode aqueous electrolyte to arrive at the surface of the anode, thereby performing the precipitation reaction of the metal lithium at the surface of the anode.

2) Reaction at cathode: 4OH⁻→O₂+2H₂O+4e⁻

The oxygen generation reaction is generated. The generated electrons are supplied to the conducting wire.

As described above, the organic electrolyte is disposed at the metal anode side and the aqueous electrolyte is disposed at the air cathode side and the metal anode side is insulated from the air electrode side by the solid separation membrane. The solid separation membrane transmits only the anode metal ions and does not transmit the rest ions. As a result, it is possible to prevent the electrolytes of the cathode and the anode from being mixed and the solid products from being generated at the cathode side. In addition, an aqueous metal hydroxide is generated in the aqueous electrolyte at the cathode side, which may reproduce the electrolyte at the cathode side in a filtering manner after the discharging.

The metal air battery according to the exemplary embodiment of the present invention may be used as a battery for a car, a fixed power supply, a home power supply, or the like. In particular, the metal air battery may be very variously used as the battery of the car. For example, if the aqueous electrolyte of the cathode is changed into the exchange type as a stand for a car and the metal aluminum at the anode side is spread in a manner such as a cassette, the car may be continuously driven without the charging waiting time.

In addition, the metal air battery according to the exemplary embodiment of the present invention may be used both in the primary and secondary batteries, but when the consumed time, cost, and capacity are consumed at the time of charging, the primary battery using only the anode as the replaceable type without charging may be more preferable.

Hereinafter, although the metal air battery according to the exemplary embodiment of the present invention is described in detail by the following example, the present invention is not limited to the following examples.

### Example 1

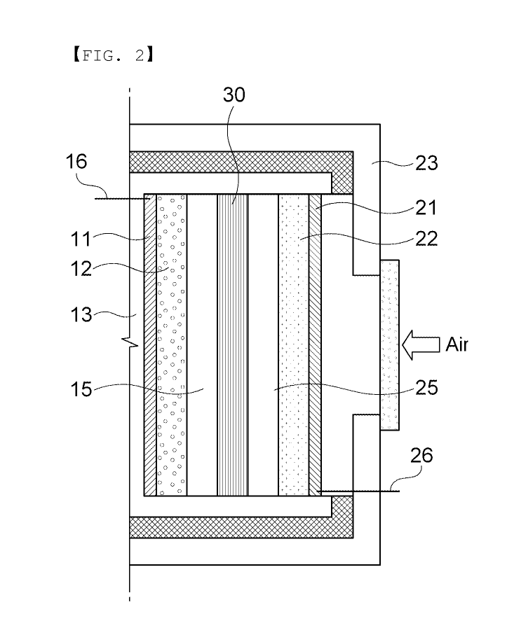

In Example 1, the aluminum air battery is prepared, the preparing of the cell is performed in an argon glove box where a dew point is −60° C. or less. The metal air battery having the following structure of FIG. 2 was prepared.

First, a lithium metal was used as the battery case. The lithium metal was disposed as the case 13 of the anode and the anode 10 including the aluminum metal as the active material layer 12 on the aluminum metal on the anode collector 11 was formed on the lithium metal.

An SiO₂ solid separation membrane 30 was formed on the anode 10 and the cathode 20 was formed on the top of the solid separation membrane 30. The cathode includes the active material layer 22 having a type where MnO₂ is mixed in the porous carbon that may more promote the oxidization reaction of air as an oxygen catalyst. In addition, the lithium metal was disposed as the case 23 of the cathode and then, a portion of the case 23 of the cathode was formed with the porous membrane 14 in order to have the open battery case into which the external oxygen may be introduced.

The aluminum anode 10 was introduced with the organic electrolyte 15, 1.2MLiPF₆/EC:PC:EMC(3:1:4) and the air cathode 20 was introduced with the aqueous electrolyte (25, pH 11), 1.2M NaOH.

### Experimental Example: Discharge Capacity Measurement

The aluminum-air battery was discharged at a discharge rate of 0.1 A/g in the air and then, the discharging capacity thereof was measured at about 2000 mAh/g.

As set forth above, the exemplary embodiment of the present invention has a structure that uses the organic electrolyte in the metal anode, uses the aqueous electrolyte in the cathode, the air electrode, and uses a solid separation membrane transmitting only the metal ions of the anode between the organic electrolyte of the anode and the aqueous electrolyte of the air electrode.

Therefore, the metal air battery according to the exemplary embodiment of the present invention can prevent each electrolyte of the cathode and the anode from being mixed and activate the battery reaction, thereby preparing the high-capacity battery.

In addition, the metal air battery according to the exemplary embodiment of the present invention can prevent the solid reaction products from being precipitated at the cathode.

In addition, the exemplary embodiment of the present invention can improve the battery stability without the risk that water, oxygen, or the like, react with the metal of the anode since water, oxygen, or the like, used as the cathode cannot transmit the solid separation membrane.

Further, the exemplary embodiment of the present invention uses the charging-only cathode at the time of charging, thereby preventing the corrosion and deterioration of the air cathode due to the charging.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A metal air battery, comprising
a metal anode and an air cathode,
wherein the metal anode includes an organic electrolyte and the air cathode includes an aqueous electrolyte.

2. The metal air battery according to claim 1, wherein the metal anode is one or more selected from a group consisting of lithium (Li), sodium (Na), potassium (K), calcium (Ca),magnesium (Mg), aluminum (Al), zinc (Zn), and an alloy thereof.

3. The metal air battery according to claim 1, wherein the air cathode includes one or more selected from a group consisting of precious metals, metal oxides, and organic metal complexes.

4. The metal air battery according to claim 3 wherein the precious metal is one or more selected from platinum (Pt), gold (Au), and silver (Ag), the metal oxide is one or more selected from manganese (Mn), nickel (Ni), and cobalt (Co), and the organic metal complex is one or more selected from metalloporphyrin and metal phthalocyanine.

5. The metal air battery according to claim 1, wherein the organic electrolyte and the aqueous electrolyte include a lithium containing compound as an electrolytic salt.

6. The metal air battery according to claim 5, wherein the lithium containing compound is one or more selected from a group consisting of LiPF₆, LiBF₄, LiClO₄, LiN(SO₂CF₃)₂, LiN(SO₂C₂F₅)₂, CF₃SO₃Li, LIC(SO₂CF₃)₃, LiAsF₆, LiSbF₆, LiI, LiCF₃CO₂, LiPF₃(C₂F₅)₃, LiF₃(C₂F₅)₃, LiF₃(CF₃)₃, LiPF₄(C₂F₅)₂, LiPF₄(CF₃)₂, LiPF₅(C₂F₅), and LiPF₅(CF₃).

7. The metal air battery according to claim 1, wherein a solvent of the organic electrolyte includes one or more selected from a group consisting of ethylene carbonate, propylene carbonate, butylene carbonate, ethyl methyl carbonate, diethyl carbonate, dimethyl carbonate, dimethyl ether, diethyl ether, tetrahydrofuran, methyl tetrahydrofuran, dioxolane, methyl dioxolane, sulfolane, γ-butyrolactone, dimethyl formamide, dimethyl sulfoxide, dimethoxy ethane, ethyl acetate, methyl acetate, methyl lactate, and ethyl propionate.

8. The metal air battery according to claim 1, wherein the aqueous electrolyte is an alkaline electrolyte having a pH of 10 to 12.5.

9. The metal air battery according to claim 1, wherein a separation membrane is included between the organic electrolyte and the aqueous electrolyte.

10. The metal air battery according to claim 9, wherein the separation membrane is a solid separation membrane that transmits only metal ions configuring a metal anode.

11. The metal air battery according to claim 10, wherein the solid separation membrane is a solid inorganic separation membrane made of one or more selected from a group consisting of silicon (Si), titanium (Ti), zirconium (Zr), aluminum (Al), calcium (Ca), and magnesium (Mg).

12. The metal air battery according to claim 9, wherein the separation membrane is an organic polymer/inorganic complex separation membrane without reactivity against the electrolyte.

13. The metal air battery according to claim 12, wherein the organic polymer is an oxygen (—O—) atom containing organic polymer compound of a weight-average molecular average of 100,000 to 5,000,000.

14. The metal air battery according to claim 13, wherein the organic polymer compound is one or more selected from polyethylene oxide, polypropylene oxide, polyoxymethylene, and derives thereof.

15. The metal air battery according to claim 13, wherein the inorganic matter is one or more selected from a group consisting of silicon (Si), titanium (Ti), zirconium (Zr), aluminum (Al), calcium (Ca), and magnesium (Mg).

16. A method for preparing a metal air battery, comprising:
preparing a metal anode;
preparing an air cathode;
forming a solid separation membrane between the metal anode and the air cathode;
impregnating an organic electrolyte in the metal anode; and
impregnating an aqueous electrolyte in the air cathode.
